(19) United States
(12) Patent Application Publication
(10) Pub. No.: US 2008/0031262 A1
(43) Pub. Date: Feb. 7, 2008

(54) LOAD-BALANCED SWITCH ARCHITECTURE FOR REDUCING CELL DELAY TIME

(75) Inventors: Hideki NISHIZAKI, Tokyo (JP); Kenshin YAMADA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/833,835

(22) Filed: Aug. 3, 2007

(30) Foreign Application Priority Data
Aug. 4, 2006 (JP) 2006-213889

(51) Int. Cl. H04L 12/56

(52) U.S. Cl. 370/395.71

(57) ABSTRACT

A switch apparatus is provided with a plurality of input interfaces, a plurality of intermediate buffers; a plurality of output interfaces; an input-side switch providing connections between the input interfaces and the intermediate buffers; and an output-side switch providing connections between the intermediate buffers and the output interfaces. Each of the plurality of input interfaces is provided with a plurality of pointers for each of the output interfaces, each of the plurality of pointers containing a pointer value indicating one of the intermediate buffers. The plurality of input interfaces are each designed to select one of the plurality of pointers and to forward arriving cells to desired ones of the plurality of intermediate buffers starting from selected one of the plurality of intermediate buffers in response to a pointer value contained in the selected one of the plurality of pointers.

### BACKGROUND ART

1. Field of the Invention

The present invention relates to switch apparatuses, especially to switch apparatuses for high-speed and high-capacitance cell switching, such as ATM (asynchronous transfer mode) switches.

2. Description of the Related Art

General cell switch configurations include an input-buffer switch, an output-buffer switch, and a shared-buffer switch.

FIG. 1 is a block diagram illustrating an exemplary structure of an input-buffer switch. In an input-buffer switch, an input buffer 101 is provided for each input port, which queues fixed-length cells. The input buffers 101 are connected with a cross-bar switch 102. The input buffers 101 are used to queue cells when cells inputted to different input ports are to be transmitted to the same destination output ports. As is well known in the art, the input-buffer switch configuration suffers from HOL blocking (head of line). If the cell at the front of a queue is blocked, other cells in the queue cannot be forwarded to desired output ports; even if the second cell in the queue are free from output port blocking, the second cell cannot to be forwarded.

One approach for avoiding the HOL blocking is VOQ (virtual output queuing) configuration. In an input-buffer switch adapted to VOQ, as shown in FIG. 2, a set of input buffers 101-1 to 101-N are provided for each input port, the number of input buffers for each input port being identical to the number of the output ports. The VOQ configuration, however, suffers from the increase in the calculation amount necessary for cell scheduling, which involves determining from which cell arriving at input port is to be next forwarded to the destination output port; cell scheduling is required for all the possible routes, the number of which is identical to the multiple of the numbers of the input and output ports. The increase in calculation amount requires an increase in the hardware size, and causes difficulties in implementation, especially when the number of input/output ports is increased.

FIG. 3 is a block diagram illustrating an exemplary structure of an output-buffer switch. A typical output buffer switch is provided with a cross-bar switch 102, and output buffers 103 provided for the output ports, respectively. The cross-bar switch 102 concurrently handles cells inputted to the respective input ports, and forward the cells to desired output ports with the data transmission rate of N times as high as the data input rate, where N is the number of input ports. The output buffers 103 are used to queue cells from the input ports, when cells from different input ports are forwarded to the same output port. This switching configuration requires the cross-bar switch 102 to process the cells at the processing rate of N times as high as the interface rate, and causes difficulties in implementation, especially when the high port rate is required and/or when the number of input/output ports is increased.

FIG. 4 is a block diagram illustrating an exemplary structure of a shared buffer switch. A typical buffer switch is provided with an input-side switch 104, a buffer 105, and an output-side switch 106. The input-side switch 104 concurrently handles cells inputted to the respective input ports, and forwards the cells to the buffer 105 with a data write rate of N times as high as the input port rate, where N is the number of input ports. The output-side switch 106 receives the cells from the buffer 105 at the same rate as the data write rate, and forwards the cells to desired output ports. This switching configuration requires the input-side and output side switches 104 and 106 to process the cells at the processing rate of N times as high as the interface rate, and causes difficulties in implementation, especially when the high port rate is required and/or when the number of input/output ports is increased.

A load-balanced switch is known as a switch configuration which is free from scheduling of the input/output ports as is the case with the input buffer switch, eliminating the necessity of the increase in the processing rate of the cross-bar switch incorporated therein as the increase in the number of input/output ports.

FIG. 5 is an exemplary structure of a load-balanced switch accommodating N input interfaces and N output interfaces. The load-balanced switch shown in FIG. 5 is provided with input interfaces 1-1 to 1-N, an input-side crossbar switch 2, intermediate buffers 3-1 to 3-N, an output-side crossbar switch 4, and output interfaces 5-1 to 5-N. Although being equally N in FIG. 5, the numbers of the input interfaces 1-1 to 1-N, the intermediate buffers 3-1 to 3-N, and the output interfaces 5-1 to 5-N may be different from one another. The input interfaces 1-1 to 1-N accommodate arriving cells transmitted at a transmission rate of R. The input-side crossbar switch 2 uniformly forwards the cells to the respective intermediate buffers 3-1 to 3-N; the traffic is uniformly spread to the intermediate buffers 3-1 to 3-N. Cell forwarding may be achieved by mesh connections of optical cables and so on, in place of the input-side crossbar switch 2.

The intermediate buffers 3-1 to 3-N are adapted to VOQ (virtual output queuing); the intermediate buffers 3-1 to 3-N are each designed to queue cells separately for the individual output interfaces 5-1 to 5-N. Each intermediate buffer accommodates the traffic of the transmission rate of R (which is one N-th of the total data rate N×R), that is, accommodates one N-th of the overall traffic. FIG. 5 illustrates cell switching of N cells from the input interface 1-1 to the output interface 5-1. The N cells are distributed to the intermediate buffers 3-1 to 3-N by the input-side crossbar switch 2. The cells arriving at the respective intermediate buffers 3-1 to 3-N are placed in the queue associated with the output interface 5-1 (the topmost queues of the respective intermediate buffers 3-1 to 3-N in FIG. 5). The cells are then forwarded from the respective intermediate buffers 3-1 to 3-N to desired ones of output interfaces 5-1 to 5-N by the output-side crossbar switch 4. Cell forwarding may be achieved by mesh connections of optical cables and so on, in place of the output-side crossbar switch 4.

As thus described, the load-balanced switch is designed to distribute cells to the intermediate buffers 3-1 to 3-N, and to then forward the cells from the intermediate buffers 3-1 to 3-N to the destination output interfaces. This allows reducing the load of each intermediate buffer, and eliminates the necessity of the improvement of the device processing rate accompanied by the increase in the number of the input/output ports and cell switch scheduling, inevitably implemented in the input-buffer switch.

One issue of load-balanced switches is cell spreading from the input interfaces 1-1 to 1-N to the intermediate buffers 3-1 to 3-N. When cells arrive at the input ports in units of N cells, the arriving cells can be equally spread to the intermediate buffers 3-1 to 3-N. Otherwise, cells may be unevenly distributed to the intermediate buffers 3-1 to 3-N; a specific intermediate buffer may receive an increased number of cells. When cells are all distributed to one specific intermediate buffer receives, the throughput is decreased down to 1/N of the original port rate, because the intermediate buffers 3-1 to 3-N each operate at a speed of 1/N of the port rate of the input/output ports, and totally provide switching at the rate of the original port rate.

Therefore, it is important for a load-balanced switch to uniformly spread cells to the intermediate buffers 3-1 to 3-N. There are two major cell spreading techniques: Uniform Frame Spreading (UFS) and Full Ordered Frames First (FOFF).

The UFS is a technique in which cells associated with the same destination output interface are spread to the intermediate buffers 3-1 to 3-N in units of N cells so that all the queues have the same length, and then forwarded from the intermediate buffers 3-1 to 3-N to the destination output interface, in this order of the intermediate buffers 3-1, 3-2, . . . 3-N. When the number of cells to be forwarded to each destination output interface is less than N, fake cells are inserted to allow spreading the cells in units of N cells. This allows the number of cells in the queues of the intermediate buffers to be same. The UFS also allows the preserving the order of the cells, eliminating the necessity of cell reordering in the output interfaces 5-1 to 5-N.

In the FOFF technique, on the other hand, each input interface is designed to memorize the intermediate buffer to which the each input interface last transmits the cell, and to deliver a newly arriving cell to the next intermediate buffer. This allows the queues of the intermediate buffers 3-1 to 3-N to have the same length. The use of the FOFF technique may result in that the order of the cells arriving at the output interfaces is reversed; however, the FOFF technique, which cyclically spreads cells to the intermediate buffers 3-1 to 3-n cell by cell, allows easy cell reordering, because the maximum cell delay between the cells relevant to the cell reordering is predictable.

The UFS technique always spreads the cells from the input interfaces to the intermediate buffers in units of N cells. Each set of N cells are always forwarded to the intermediate buffers in the order from the leading intermediate buffer (that is, the intermediate buffer 3-1 in FIG. 5). The input-side crossbar switch 2 is configured to cyclically forward a cell to selected one of the in each time slot. Therefore, the cell spreading requires a waiting period until the timing when the input-side crossbar switch 2 after an input interface prepares a complete set of N cells.

FIG. 6 illustrates the exemplary procedure in the case that the number of the input interfaces is four. Four cells successively arrive at an input interface from the time slot “3” to the time slot “6”, and therefore a complete set of four cells are prepared in the input interface. However, the cell spreading of this set of four cells has to be delayed until the time slot “9”, because the first one of a complete set of four cells is always delivered to the leading intermediate buffer (that is, the intermediate buffer 3-1) as is indicated by the symbol “#1” in FIG. 6. This implies that the UFS technique suffers from a problem that the waiting time before actual cell spreading to the intermediate buffers increases as the increase in the number of the intermediate buffers. The same applies to the FOFF technique; cells are forwarded starting from specific one of the intermediate buffers, although the specific one intermediate buffer is not limited to the leading buffer.

As thus described, the UFS and FOFF techniques suffer from the increased waiting time from the preparation of a complete set of cells to actual cell spreading to the intermediate buffers, especially when the number of interfaces is increased, because the first cell is destined to be forwarded to specific one of the intermediate buffers.

In summary, the input buffer switch faces difficulties in cell scheduling for all the input/output ports, while the output buffer switch and the shared buffer switch undesirably requires cell switching at a higher speed for providing high speed interfacing for an increased number of ports. Although solving these problems, the load balanced switch suffers from cell transmission delay (delay from cell arrival to cell output) in accommodating an increased number of ports.

Japanese Laid-Open patent Application No. 2000-13434 discloses a packet multiplexer as a related art. The packet multiplexer is designed to change the order of extracting packets from first to n-th input ports, each time one packet is extracted from every input port once. The order of extracting packets from the input ports is controlled as to be allocated with the same probability from first one to n-th one. Further, the first to the n-th input ports are selected with the same frequency as the input port from which a packet is extracted just before for each input port. Specifically, the packet multiplexer is designed to select appropriate one of the input ports by using a plurality of pointers, and to extract a packet from the selected input port.

Japanese Laid-Open Patent Application No. 2000-349786 discloses a shared buffer switch for high-speed input/output interfacing. In the address management of the shared buffer switch, multiple output order chains including a write address register 20 and a read address register 30 are allocated for each packet flow. A sorting pointer 22 and a writing address register selection circuit 21 which perform cyclic sorting of cells of the flow associated with the multiple output order chains and a reading pointer 32 and a reading address register selection circuit 31 which perform cyclic reading from the plural output order chains are provided so that pipeline reading can be performed by using these multiple output order chains.

Japanese Laid-Open Patent Application No. 2002-164902 discloses an input buffer switch for transmitting digital data in units of cells. The disclosed input buffer switch is provided with an input buffer section and first and second schedulers for each input port, the input buffer section including a set of logic buffers associated with the output ports respectively. Additionally, third and fourth schedulers are provided for each output port. It should be noted that multiple logic buffers are provided for each output port.

Japanese Laid-Open Patent Application No. 2002-164914 discloses modified input buffer switch architecture. The input buffer switch disclosed in this document includes a set of line interface receivers receiving packets, a set of line interface transmitters, and a switch section transferring the packets received by the line interface receivers to the line interface transmitters associated with the desired output routes of the packets. The line interface receivers are prepared for the input ports, respectively, and the line interface transmitters are prepared for the output ports, respectively. Each line interface receiver includes an output route selector selecting output routes for the packets and a set of buffers prepared for the output routes, respectively. The switch section includes size-reduced buffers prepared for the buffers within the line interface receivers, respectively. The switch section further includes an input section which informs the availabilities of the size-reduced buffers to the associated line interface receivers and an output section which receives the packets stored in the size-reduced buffers and transmits the received packets to the line interface transmitters associated with the desired output routes of the packets.

### SUMMARY

Therefore, an exemplary object of the present invention is to provide a load-balanced switch architecture for reducing waiting time in cell spreading to the intermediate buffers after a complete set of cells are prepared in input interfaces, and thereby reducing cell delay time.

In an aspect of the present invention, a switch apparatus is provided with a plurality of input interfaces, a plurality of intermediate buffers; a plurality of output interfaces; an input-side switch providing connections between the input interfaces and the intermediate buffers; and an output-side switch providing connections between the intermediate buffers and the output interfaces. Each of the plurality of input interfaces is provided with a plurality of pointers for each of the output interfaces, each of the plurality of pointers containing a pointer value indicating one of the intermediate buffers. The plurality of input interfaces are each designed to select one of the plurality of pointers and to forward arriving cells to desired ones of the plurality of intermediate buffers starting from one of the plurality of intermediate buffers in response to a pointer value contained in the selected one of the plurality of pointers.

### BRIEF DESCRIPTION OF THE DRAWINGS

FIG. 1 is a block diagram illustrating a typical structure of an input-buffer switch;

FIG. 2 is a block diagram illustrating a typical structure of an input-buffer switch adapted to VOQ (virtual output queue);

FIG. 3 is a block diagram illustrating a typical structure of an output-buffer switch;

FIG. 4 is a block diagram illustrating a typical structure of a shared-buffer switch;

FIG. 5 is a block diagram illustrating a typical structure of a load-balanced switch with N input interfaces and N output interfaces;

FIG. 6 is a diagram illustrating the waiting time from the timing when the preparation of cells is completed in an input interface to the timing when the cells are actually transferred to the intermediate buffers;

FIG. 7 is a block diagram illustrating the structure of a load-balanced switch in an exemplary embodiment;

FIG. 8 is a block diagram illustrating an exemplary internal configuration of input interfaces;

FIG. 9 is a flowchart illustrating the operation of the load-balanced switch shown in FIG. 7;

FIG. 10 is a flowchart illustrating the operation of the input interfaces shown in FIG. 8;

FIG. 11 is a conceptual diagram illustrating an exemplary operation of an input-side crossbar switch;

FIG. 12 is a conceptual diagram illustrating an exemplary operation of an output-side crossbar switch;

FIG. 13 is a conceptual diagram illustrating the delay in cell forwarding from an input interface to intermediate buffers for the case that only one pointer is prepared for each cell route (equivalent to the case that the FOFF technique is used for cell spreading);

FIG. 14 is a conceptual diagram illustrating the delay in cell forwarding from an input interface to intermediate buffers in an exemplary embodiment in which two pointers are prepared for each cell route;

FIG. 15 is a conceptual diagram illustrating the delay in cell forwarding from an input interface to intermediate buffers in another exemplary embodiment in which two pointers are prepared for each cell route; and

FIG. 16 is a conceptual diagram illustrating the delay in cell forwarding from an input interface to intermediate buffers in still another exemplary embodiment in which two pointers are prepared for each cell route.

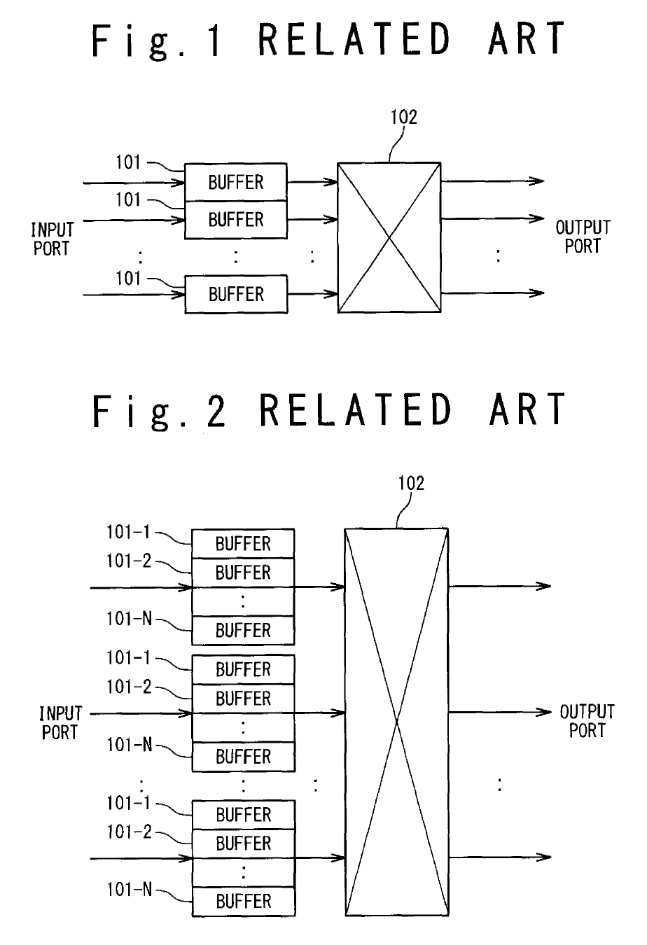

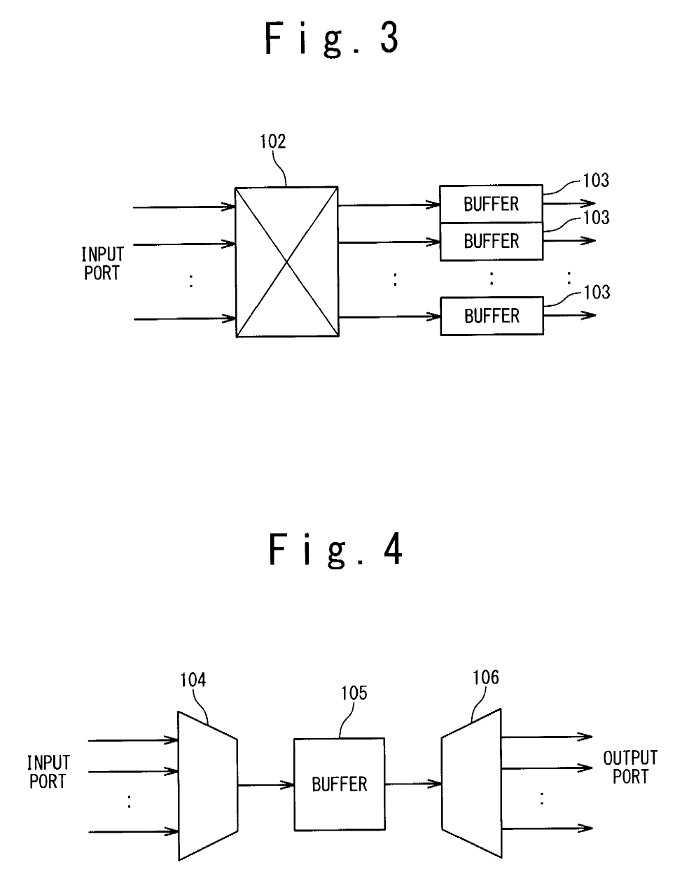

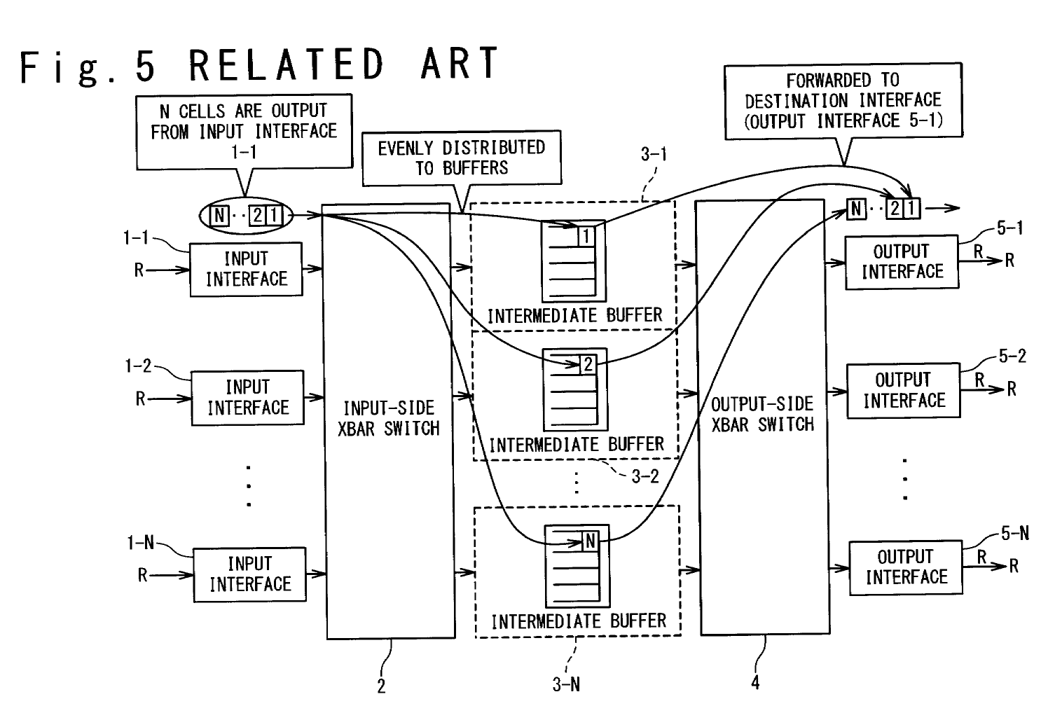

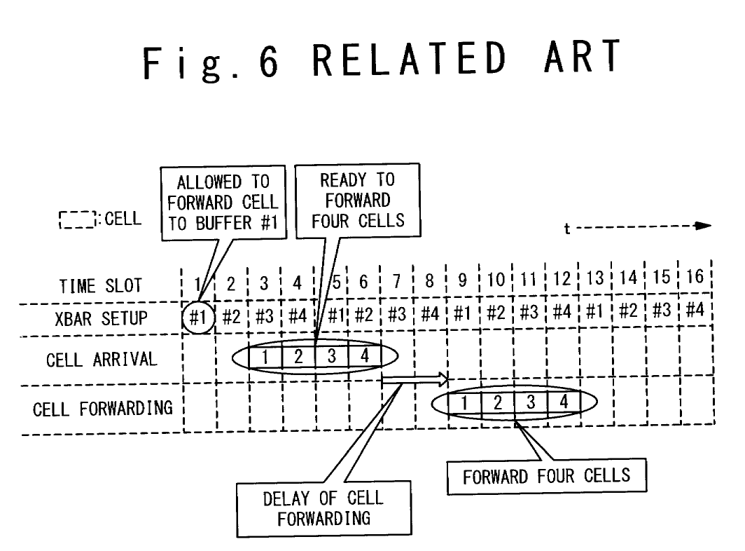

### DETAILED DESCRIPTION OF PREFERRED EMBODIMENTS

In one embodiment, a switch apparatus is provided with a plurality of input interfaces, a plurality of intermediate buffers; a plurality of output interfaces; an input-side switch providing connections between the input interfaces and the intermediate buffers; and an output-side switch providing connections between the intermediate buffers and the output interfaces. Each of the plurality of input interfaces is provided with a plurality of pointers for each of the output interfaces, each of the plurality of pointers containing a pointer value indicating one of the intermediate buffers. The plurality of input interfaces are each designed to select one of the plurality of pointers and to forward arriving cells to desired ones of the plurality of intermediate buffers starting from selected one of the plurality of intermediate buffers in response to a pointer value contained in the selected one of the plurality of pointers.

In an exemplary embodiment, each of the plurality of input interfaces is designed to store first queues associated with the output interfaces, respectively, to place respective arriving cells in selected ones of the first queues on the basis of destination output interfaces thereof, and to uniformly forward the cells of the same destination output interface to the desired ones of the intermediate buffers through the input-side switch. In this case, each of the plurality of intermediate buffers is designed to store second queues associated with the plurality of output interfaces, respectively, to place respective cells received from the input-side switch in selected ones of the second queues on the basis of destination output interfaces thereof, and to sequentially forward cells to desired ones of the output interfaces through the output-side crossbar switch. Additionally, each of the output interfaces is designed to check an order of cells received from the output-side crossbar switch, and to provide cell reordering for the cells received from the output-side crossbar switch.

In an exemplary embodiment, each of the input interfaces is designed to select the selected one of the plurality of pointers so that a waiting time is reduced as short as possible in forwarding the cells to the desired ones of the plurality of intermediate buffers.

In another exemplary embodiment, each of the input interfaces is designed to determine a least waiting time pointer which causes the least waiting time out of the plurality of pointers, to determine one or more neighbor pointers each containing a pointer value, the difference of which from a pointer value of the least waiting time pointer is equal to or less than a predetermined value, the neighbor pointers including the least waiting time pointer, and to determine one of the neighbor pointers as the selected one of the plurality of pointers so that the determined one of the neighbor pointers causes the largest waiting time output the neighbor pointers, when there are multiple neighbor pointers.

In still another exemplary embodiment, the pointers include a forward pointer, and a reverse pointer. In this case, the input interfaces are each designed to incrementally update the selected one of the plurality of pointers when the forward pointer is selected as the selected one, and to decrementally update the selected one of the plurality of pointers when the reverse pointer is selected as the selected one.

Preferably, the input interfaces are each designed to update the selected one of the plurality of pointers in response to a number of the cells forwarded to the desired ones of the plurality of intermediate buffers.

In still another embodiment, a switching method includes:

providing a switch apparatus including a plurality of input interfaces, a plurality of intermediate buffers, and a plurality of output interfaces, wherein each of the plurality of input interfaces includes a plurality of pointers for each of the plurality of output interfaces, and each of the plurality of pointers indicates one of the plurality of intermediate buffers;

selecting one of the plurality of pointers within one of the input interfaces; and

sequentially forwarding cells of the same destination output interface from the one of the input interfaces to desired ones of the plurality of intermediate buffers starting from selected one of the plurality of intermediate buffers as indicated by a pointer value contained in the selected one of the plurality of pointers.

Preferably, the selected one of the plurality of pointers is selected so that a waiting time is reduced as short as possible in forwarding the cells to the desired ones of the plurality of intermediate buffers.

In a preferred embodiment, the method may further include updating the selected one of the plurality of pointers in response to a number of the cells forwarded to the desired ones of the plurality of intermediate buffers.

In one exemplary embodiment, the step of sequentially forwarding includes:

placing respective arriving cells in selected ones of first queues within the one of the input interfaces, on the basis of destination output interfaces of the arriving cells, associated with the output interfaces, respectively; and

forwarding the cells of the same destination output interface from the one of the input interfaces to the desired ones of the plurality of intermediate buffers through an input-side switch;

wherein the method further comprising:

by each of the plurality of intermediate buffers, placing respective cells received from the input-side switch in selected ones of second queues associated with the output interfaces, respectively, on the basis of destination output interfaces thereof,

sequentially forwarding cells to desired ones of the output interfaces through the output-side crossbar switch through an output-side switch; and

by each of the output interfaces, checking an order of cells received from the intermediate buffers, and providing cell reordering for the cells received from the intermediate buffers.

In the following, various exemplary embodiments of the present invention will be described below in detail with reference to the attached drawings.

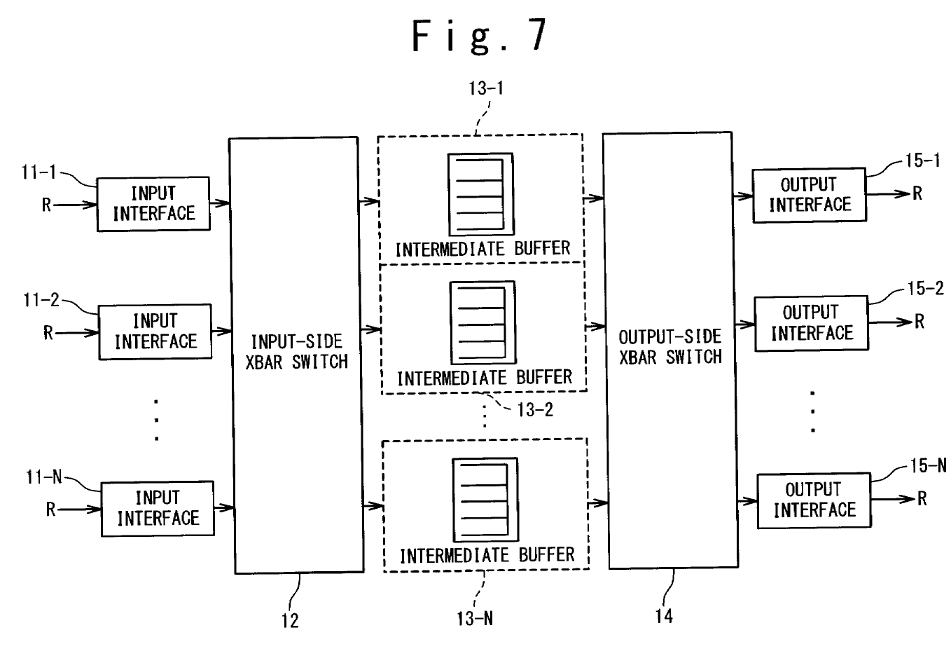

FIG. 7 is a block diagram illustrating the structure of a load-balanced switch in an exemplary embodiment. The load-balanced switch in FIG. 7 is designed to accommodate N input interfaces and N output interfaces, N being an integer more than one.

The load-balanced switch of this exemplary embodiment is provided with input interfaces 11-1 to 11-N, an input-side crossbar switch 12, intermediate buffers 13-1 to 13-N, an output-side crossbar switch 14, and output interfaces 15-1 to 15-N. It should be noted that the numbers of the input interfaces, the intermediate buffers and the output interfaces may be different from one another.

The input interfaces 11-1 to 11-N each receive arriving cells and temporarily store the received cells. The input interfaces 11-1 to 11-N forward the received cells to the input-side crossbar switch 12.

The input-side crossbar switch 12 provides connections between the input interfaces 11-1 to 11-N and the intermediate buffers 13-1 to 13-N. The input-side crossbar switch 12 cyclically changes the connection setup thereof; the input-side crossbar switch 12 cyclically connects each input interface to the intermediate buffers 13-1 to 13-N in sequence.

The timings when the input interfaces 11-1 to 11-N forward the received cells are determined on the basis of the connection setup of the input-side crossbar switch 12. When a certain input interface desires to forward a cell to a desired intermediate buffer, the input interface transfers the cell at the timing when the input-side crossbar switch 12 establishes a connection between the input interface and the desired intermediate buffer. It should be noted that cell forwarding to the intermediate buffers may be achieved by mesh connections of optical cables and so on, in place of the input-side crossbar switch 12.

The intermediate buffers 13-1 to 13-N are adapted to virtual output queuing (VOQ); each intermediate buffer includes a set of buffers associated with the output interfaces 15-1 to 15-N, respectively, each buffer storing cells destined to the associated output interface. The intermediate buffers 13-1 to 13-N forward the received cells to the output-side crossbar switch 14.

The output-side crossbar switch 14 provides connections between the intermediate buffers 13-1 to 13-N and the output buffers 15-1 to 15-N. The output-side crossbar switch 14 cyclically changes the connection setup thereof, as is the case with the input-side crossbar switch. The timings when the intermediate interfaces 13-1 to 13-N forward the received cells are determined on the basis of the connection setup of the output-side crossbar switch 14. It should be noted that cell forwarding to the output interfaces may be achieved by mesh connections of optical cables and so on, in place of the output-side crossbar switch 14.

The output interfaces 15-1 to 15-N receives cells from the output-side crossbar switch 14 and externally output the received cells. The output interfaces 15-1 to 15-N are configured to provide cell reordering; the output interfaces 15-1 to 15-N check the order of the received cells for each of the input interfaces 11-1 to 11-N, and the output interfaces 15-1 to 15-N provides cell reordering, when the cell order is reversed.

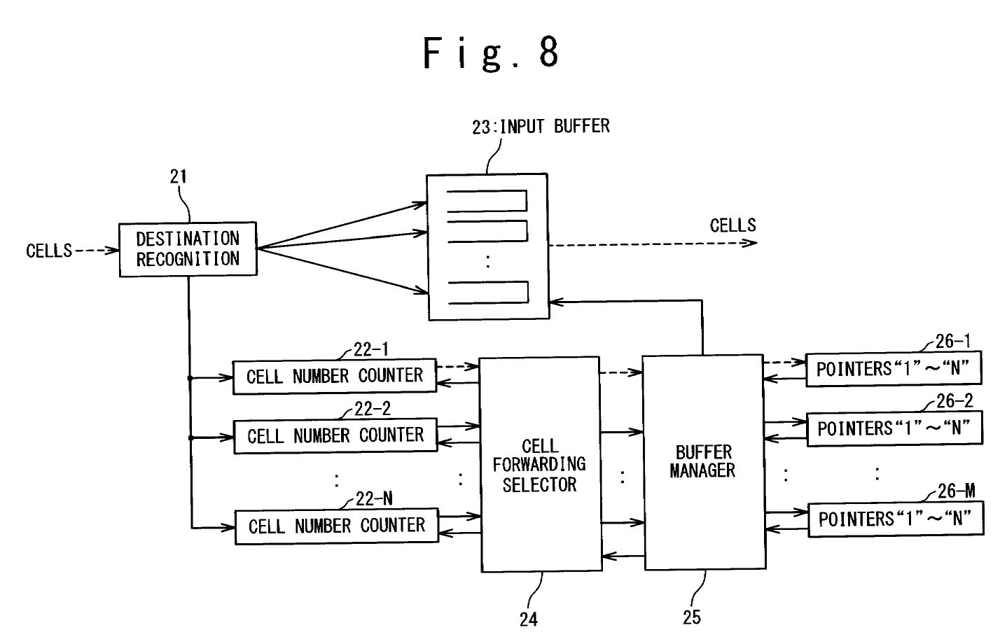

FIG. 8 is a block diagram illustrating an exemplary configuration of the input interfaces 11-1 to 11-N. Each of the input interfaces 11-1 to 11-N is provided with a destination recognition section 21, N cell number counters 22-1 to 22-N, an input buffer 23, a cell forwarding selector 24, a buffer manager 25, and M pointer sets 26-1 to 26-M, M being an integer equal to or more than two. The input buffer 23 are adapted to virtual output queuing (VOQ), including N buffers storing queues associated with the output interfaces 15-1 to 15-N, respectively. Each of the M pointer sets 26-1 to 26-M includes a set of N pointers “1” to “N” that are associated with the output interfaces 15-1 to 15-N, respectively. In other words, M pointers are prepared for each of the output interfaces 15-1 to 15-N.

The destination recognition section 21 recognizes the destinations of the respective arriving cells. In this embodiment, the destination recognition section 21 are informed about the destination output interfaces of the respective arriving cells by cell headers, or other additional data accompanying the arriving cells. The destination recognition section 21 places each arriving cell in one of the queues of the input buffer 23, the one being associated with the destination output interface. Additionally, when a cell arrives which is destined to a certain destination output interface, the destination recognition section 21 issues a cell arrival notice to associated one of the cell number counters 22-1 to 22-N.

The input buffer 23 receives the arriving cells from the destination recognition section 21, and forwards desired cells to the input-side crossbar switch 12 under the control of the buffer manager 25. As described above, the input buffer 23 is adapted to VOQ.

The cell number counter 22-1 to 22-N contain counter values indicative of the numbers of the cells placed in the queues associated with the output interfaces 15-1 to 15-N, respectively. The cell number counter 22-1 to 22-N are counted up in response to cell arrival notices received from the destination recognition section 21, and counted down in response to cell forward notices received from the cell forwarding selector 24. The counter values of the cell number counter 22-1 to 22-N are fed to the cell forwarding selector 24.

The cell forwarding selector 24 generates cell queuing information indicative of the respective states of the queues associated with the respective output interfaces 15-1 to 15-N, on the basis of the counter values of the cell number counter 22-1 to 22-N. It should be noted that the counter values of the cell number counter 22-1 to 22-N indicate the numbers of the cells placed in the queues associated with the output interfaces 15-1 to 15-N. For example, the cell queuing information may indicate for each queue that “N or more cells are placed in the queue”, “one to N−1 cells are placed in the queue”, or “no cell is placed in the queue”. The cell forwarding selector 24 feeds the cell queuing information for each queue to the buffer manager 25.

The buffer manager 25 controls the cell forwarding from the input buffer 23 to the input-side crossbar switch 12. Specifically, the buffer manager 25 determines (1) from which queue cells are forwarded from the input buffer 23 to the input-side crossbar switch 12 and (2) which pointer is used in forwarding the cells, on the basis of (a) the cell queuing information, (b) the pointer values of the pointers within the pointer sets 26-1 to 26-M, and (c) the connection setup of the input-side crossbar switch 12. In forwarding cells destined to the output interface 15-i (that is, forwarding the cells placed in the queue associated with the output interface 15-i), the buffer manager 25 selects a pointer from the M pointers “i” of the pointer sets 26-1 to 26-M. Additionally, the buffer manager 25 generates the cell forward notices indicative of the number of the cells having forwarded from the input buffer 23 to the input-side crossbar switch 12, and the destination output interface of the forwarded cells.

The pointers “1” to “N” within the pointer sets 26-1 to 26-M each contain a pointer value indicating one of the intermediate buffers 13-1 to 13-N, to which the finally forwarded cell is forwarded. A pointer value of a certain pointer is updated by the buffer manager 25 when the pointer is used in cell forwarding. As described below, cells destined to the output interface 15-i are spread to desired ones of the intermediate buffers 13-1 to 13-N starting from the intermediate buffer indicated by the pointer value of the pointer selected.

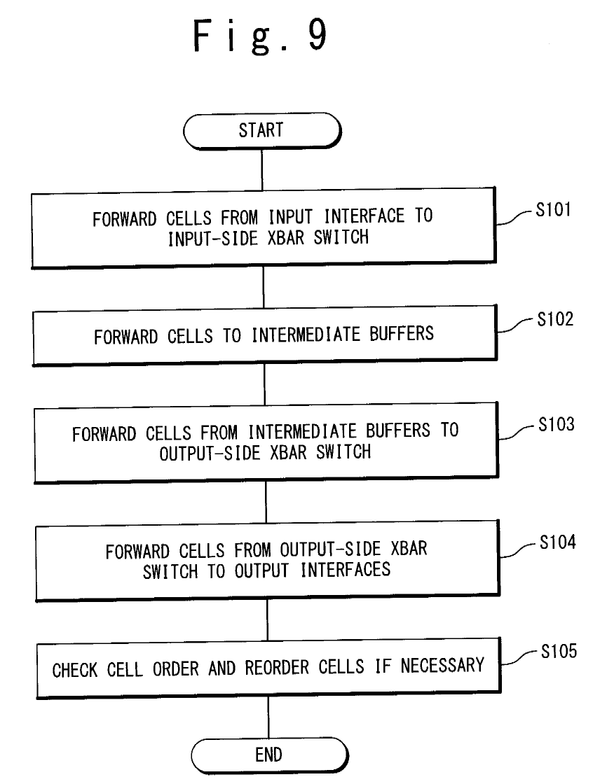

FIG. 9 is a flowchart illustrating the overall operation of the load-balanced switch of this exemplary embodiment.

### (1) Step S101

At Step S101, the input interfaces 11-1 to 11-N forwards arriving cells to the input-side crossbar switch 12. In detail, the input interfaces 11-1 to 11-N place the arriving cells in the queues associated with the destination output interfaces, and selectively forwards cells placed in the queues selected to the input-side crossbar switch 12. The timings when the input interfaces 11-1 to 11-N forwards the respective cells to the input-side crossbar switch 12 are dependent on the connection setup of the input-side crossbar switch 12. As described below, the input-side crossbar switch 12 cyclically changes the connection setup thereof, and therefore the timing when a target cell is forwarded to the input-side crossbar switch 12 should be determined depending on the destination intermediate buffer of the target cell. Details of the operation of the input interfaces 11-1 to 11-N are described later with reference to FIG. 8.

### (2) Step S102

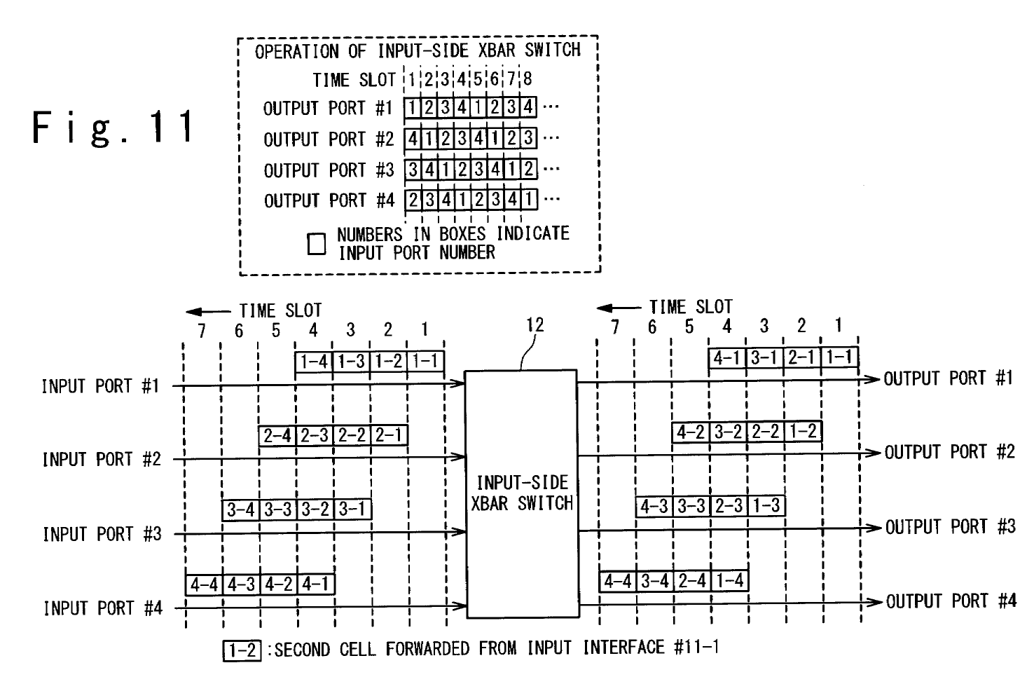

At Step S102, the input-side crossbar switch 12 switches the cells received from the input interfaces 11-1 to 11-N to desired ones of the intermediate buffers 13-1 to 13-N. This achieves cell spreading to the intermediate buffers 13-1 to 13-N. Details of the operation of the input-side crossbar switch 12 are described later with reference to FIG. 11.

### (3) Step S103

The intermediate buffers 13-1 to 13-N places the received cells in the queues associated with the destination output buffers thereof. The cells in the queues are forwarded in sequence to the output-side crossbar switch 14, at the timings determined so that the cells are forwarded to desired ones of the output interfaces 15-1 to 15-N.

### (4) Step S104

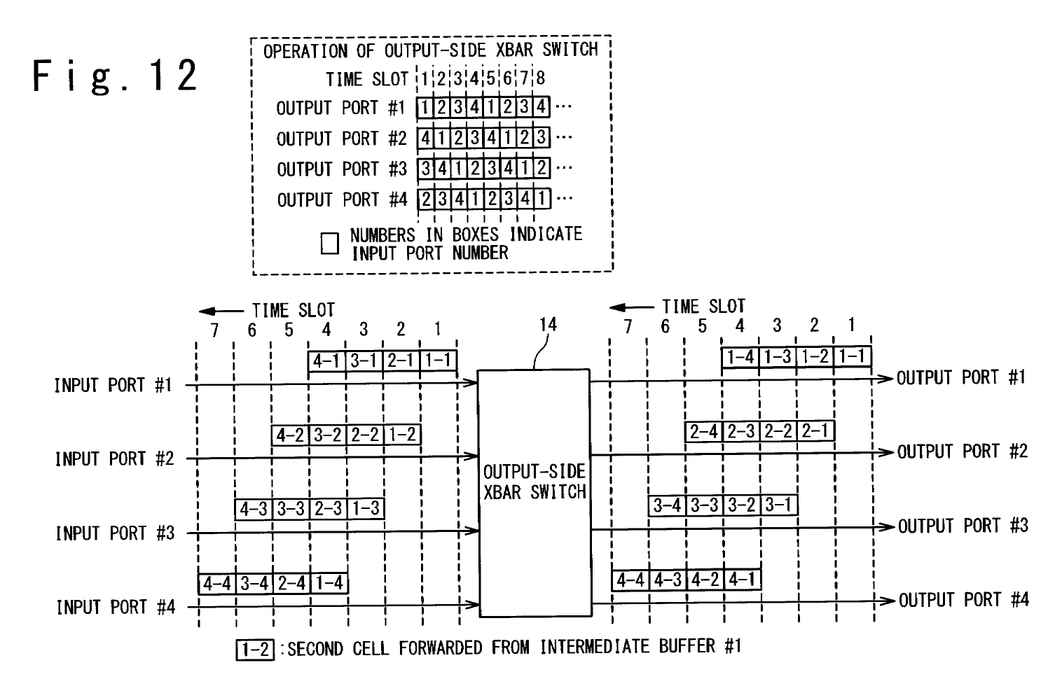

The output-side crossbar switch 14 switches the cells received from the intermediate buffers 13-1 to 13-N to desired ones of the output interfaces 15-1 to 15-N. Details of the operation of the output-side crossbar switch 14 are described later with reference to FIG. 12.

### (5) Step S105

The output interfaces 15-1 to 15-N receive the cells from output-side crossbar switch 14 and check the order of the received cell. If finding cell order reversal, the output interfaces 15-1 to 15-N perform cell reordering. The output interfaces 15-1 to 15-N outputs the cells after the cell order check and the cell reordering.

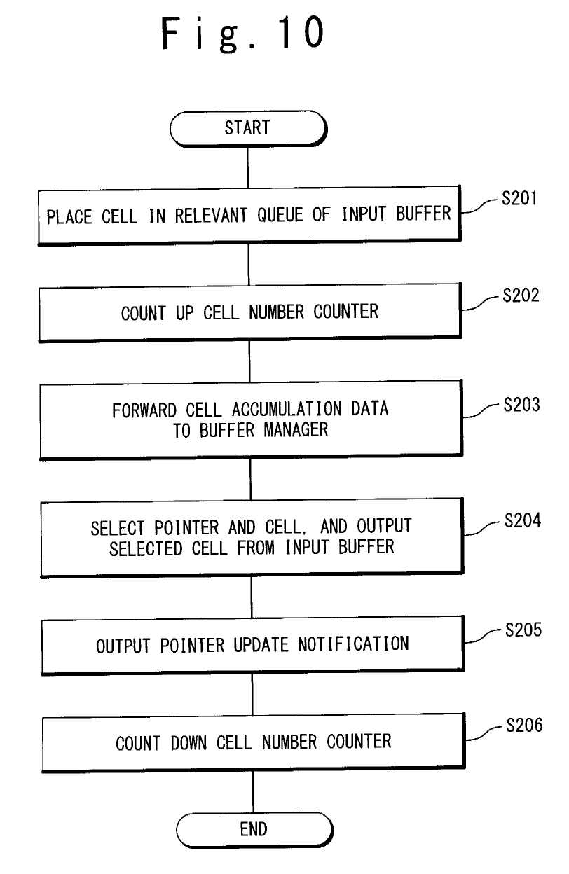

FIG. 10 is a flowchart illustrating the operation of the input interfaces 11-1 to 11-N. It should be noted that the input interfaces 11-1 to 11-N are informed in advance about the destination output interfaces of the arriving cells by the cell headers, additional data accompanying the cells, or other means.

### (1) Step S201

At Step S201, the destination recognition section 21 recognizes the destination of an arriving cell, and places the arriving cell in the queue associated with the destination output interfaces.

### (2) Step S202

At Step S202, the destination recognition section 21 issues a cell arrival notice informing the arrival of the arriving cell to associated one of the cell number counters 22-1 to 22-N. The cell number counter associated with the destination output interface of the arriving cell is counted up in response to the cell arrival notice.

### (3) Step S203

At Step S203, the cell forwarding selector 24 recognizes the numbers of the cells in the queues associated with the respective output interfaces 15-1 to 15-N from the counter values of the cell number counters 22-1 to 22-N, and generates the cell queuing information, which indicates the length of each queue, for each output interface. The cell queuing information is fed to the buffer manager 25.

### (4) Step S204

In response to the cell queuing information received from the cell forwarding selector 24, the pointer values of the pointers within the pointer sets 26-1 to 26-M, and the connection setup of the input-side crossbar switch 12, the buffer manager 25 selects cells to be forwarded next, and one of the pointers to be used in forwarding the cells. The pointer to be used is selected so that the waiting time is reduced as short as possible.

The buffer manager 25 then provides cell forwarding control to allow the input buffer 23 to forward the cells to the input-side crossbar switch 12. The cells are sequentially forwarded to desired ones of the intermediate buffers 13-1 to 13-N starting from the intermediate buffer determined by referring to the pointer value of the selected pointer. When the selected pointer contains the pointer value #i, the buffer manager 25 allows forwarding the cells to the relevant intermediate buffers starting from the intermediate buffer 13-(i+1) for i being an natural less than N, or starting from the intermediate buffer 13-1 for i being N.

It should be noted that in some cases, multiple cells can be forwarded with the shortest waiting time, because the arriving cells are separately stored and managed for the different output interfaces, and therefore different cells with different destination output interfaces may wait for being forwarded to the same intermediate buffer. In such case, the cells in the queue having the longest length may be given priority in selecting the cells to be forwarded next. Instead, the cells to be forwarded next may be selected so that the destination output interfaces of the selected cells follow the round robin scheme.

### (5) Step S205

Additionally, at Step S205, the buffer manager 25 issues a cell forward notice indicating the number of cells forwarded from the input buffers 23, and the destination output interface of the forwarded cells. The buffer manager 25 also updates the pointer used in forwarding the cells in response to the number of the forwarded cells. In detail, the pointer value of the used pointer is updated to the sum of the original pointer value and the number of the forwarded cells under modulo N arithmetic.

### (6) Step S206

The cell forwarding selector 24 receives the cell forwarding notice from the buffer manager 25, and forwards the cell forwarding notice to the relevant cell number counter. This allows the relevant cell number counter to be count down by the number of the forwarded cells.

It should be noted that the operation of the input interfaces 11-1 to 11-N, the input-side crossbar switch 12, the intermediate buffers 13-1 to 13-N, the output-side crossbar switch 14, and the output interfaces 15-1 to 15-N may be controlled by a software program stored in a recording medium.

FIG. 11 is a diagram illustrating an exemplary operation of the input-side crossbar switch 12 for the case that N is four, that is, the numbers of the input interfaces and the intermediate buffers are four. In FIG. 11, it should be noted that the input ports #1 to #4 of the input-side crossbar switch 12 are connected with the input interfaces 11-1 to 11-4, respectively, while the output ports #1 to #4 are connected with the intermediate buffers 13-1 to 13-4, respectively. The symbol “1-i” indicates the cell i-th input to the input port #1 (that is forwarded from the input interface 11-1). The symbol “2-i” indicates the cell i-th input to the input port #2 (that is forwarded from the input interface 11-2). The same goes for the input ports #3 and #4.

The input-side crossbar switch 12 cyclically changes the connection setup thereof with the cycle period of N time slots (N is four in FIG. 11). Each output port of the input-side crossbar switch 12 is switched to the input ports in sequence, time-slot by time-slot, while different output ports are connected with different input ports (See the dashed box of FIG. 11). For example, the output port #1 are connected with the input port #1, #2, #3 and #4 in the time slot “1”, “2”, “3” and “4”, respectively. In the time slot “1”, the output port #1, #2, #3 and #4 are connected with the input port #1, #4, #3 and #2 in the input-side crossbar switch 12. The corresponding sequence goes for other output ports and other time slots. Therefore, when the respective input ports each receive a series of four cells starting from the timeslots “1”, “2”, “3” and “4”, respectively, the cells to each input port are uniformly spread to the output ports starting from the output port #1.

FIG. 12 is a diagram illustrating an exemplary operation of the output-side crossbar switch 14 for the case that N is four, that is, the numbers of the intermediate buffers and the input interfaces are four. It should be noted that the input ports #1 to #4 of the output-side crossbar switch 14 are connected with the intermediate buffers 13-1 to 13-4, respectively, while the output ports #1 to #4 are connected with the output interfaces 15-1 to 15-4, respectively. In FIG. 12, the cells indicated by the symbol “1-n” (that is, the cell first received from the intermediate buffer 13-n) are destined to the output port #1 (that is, the output interface 15-1), the cells indicated by the symbol “2-n” are destined to the output port #2. Correspondingly, the cells indicated by the symbol “3-n” are destined to the output port #3, and the cells indicated by the symbol “4-n” are destined to the output port #4.

The output-side crossbar switch 14 cyclically changes the connection setup thereof with the cycle period of N time slots (N is four in FIG. 12). Each output port of the output-side crossbar switch 14 is switched to the input ports in sequence, time-slot by time-slot, while different output ports are connected with different input ports (See the dashed box of FIG. 12). Therefore, the cells received from the intermediate buffers 13-1 to 13-4 are forwarded to the desired output interfaces, although the cells with the same destination output interface are spread to different intermediate buffers.

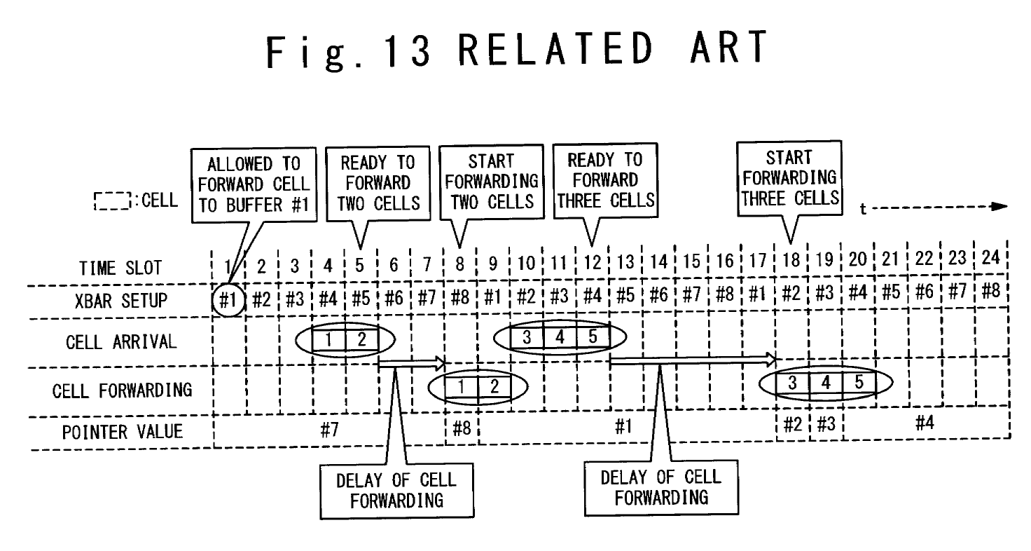

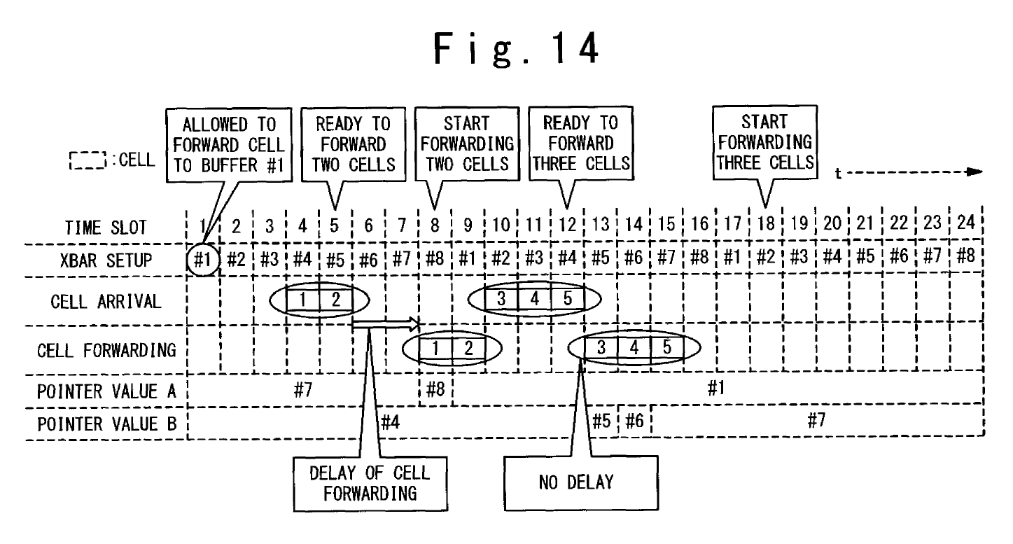

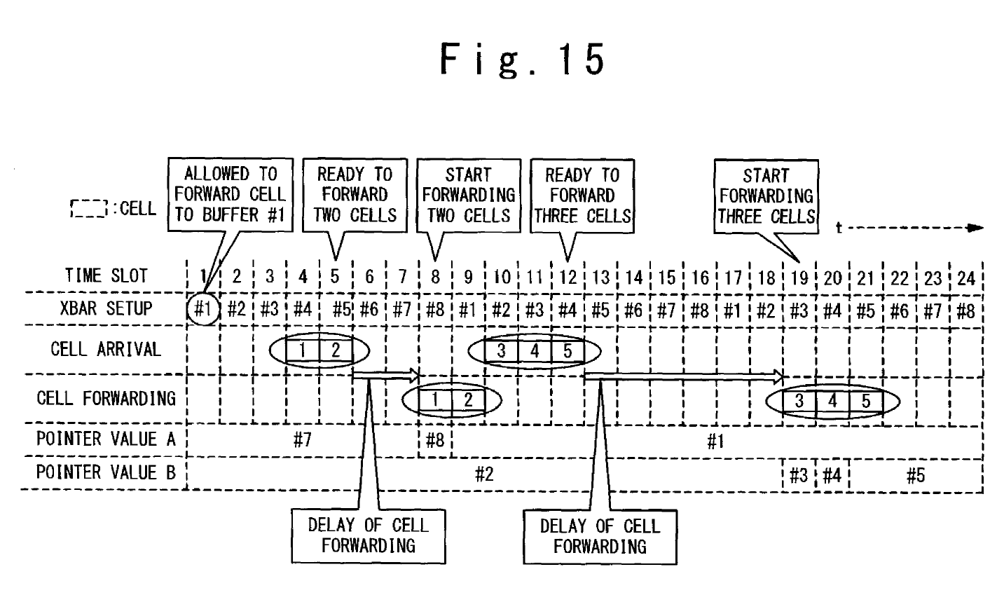

In the following, the advantage of the cell spreading in this exemplary embodiment will be discussed with reference to FIGS. 13 and 14.

FIG. 13 is a diagram illustrating the delay in cell spreading from the input interfaces 11-1 to the intermediate buffers 13-1 to 13-N for the case of FOFF (Full Ordered Frames First); this case is equivalent to the case that M is one (that is, only one pointer set 26-1 is prepared for each of the input interfaces 11-1 to 11-N). In the operation example of FIG. 13, it is assumed that the number N of the input interfaces 11-1 to 11-N is eight, and cells of the same destination output interface arrive at the same input interface. Additionally, the pointer value of the pointer within the pointer set 26-1 associated with the destination output interface is assumed to be initially set to #7. It should be noted that the row “XBAR SETUP” indicates the connection between the present input interface and the intermediate buffers 13-1 to 13-8; the symbol “#i” in the row “XBAR SETUP” indicates that the present input interface is connected with the intermediate buffer 13-i.

Although the cells #1 and #2 get ready to be forwarded at the time slot “5” in the present input interface, the cells #1 and #2 wait to be forwarded to the relevant intermediate buffers until the input-side cross bar switch 12 is set to provide a connection between the present input interface to the intermediate buffer 13-8 as indicated by the symbol “#8” at the time slot “8”, since the pointer associated with the output destination contains the pointer value of #7 indicating the intermediate buffer 13-7. After the cells #1 and #2 are forwarded to the relevant intermediate buffers 13-8 and 13-1, respectively, the pointer associated with the output destination is updated from “#7” to “#2”, in response to the fact that two cells are forwarded.

After that, the cells #3 to #5 are get ready to be forwarded at the time slot “12” in the present input interface; however, the cells #3 to #5 waits to be forwarded until the time slot “18”, at which the input-side crossbar switch 12 provides the connection between the present input interface and the intermediate buffer 13-2, since the pointer associated with the destination output buffer is set to #1. After the cells #3 to #5 are forwarded, the pointer associated with the destination output buffer is updated from #1 to #4, in response to the fact that three cells are forwarded to the relevant intermediate buffers. As thus described, the FOFF technique suffers from an increased waiting time in cell spreading.

The cell spreading scheme of the present exemplary embodiment, on the other hand, effectively reduces the waiting time in cell spreading to the intermediate buffers 13-1 to 13-N.

FIG. 14 is a diagram illustrating the illustrating the delay in cell spreading from the input interfaces 11-1 to the intermediate buffers 13-1 to 13-N in this exemplary embodiment, in which multiple pointers are prepared for each output interface. It is assumed in the operation of FIG. 14 that M is two (that is, two pointer sets 26-1 and 26-2 are prepared in each of the input interfaces 11-1 to 11-N), the number N of the input interfaces is eight, and cells of the same destination output interface arrive the same input interface. The pointer associated with the destination output interface within the pointer set 26-1 is referred to as the pointer A, while the pointer within the pointer set 26-2 is referred to as the pointer B, hereinafter. Initially, the pointer value of the pointer A is set to #7, and that of the pointer B is set to #4.

The cells #1 and #2 get ready to be forwarded at the time slot “5” in the present input interface. One of the pointers A and B are selected in forwarding the cells #1 and #2 so that the waiting time is reduced as short as possible. In this case, the pointer A, containing a pointer value of #7, is selected so as to forward the cells #1 and #2 to the intermediate buffers 13-8 and 13-1 at the time slots #8 and #1, respectively. After the cell forwarding of the cells #1 and #2, the pointer A is updated from #7 to #1, in response to the fact that two cells are forwarded.

After that, the cells #3 to #5 are get ready to be forwarded at the time slot “12” in the present input interface. The cells #3 to #5 are immediately forwarded to selected intermediate buffers starting from the time slot “13” at which the input-side crossbar switch 12 provides the connection between the present input interface and the intermediate buffer 13-5, since the pointer B, which contains a pointer value of #4, is selected to reduce the waiting time as short as possible. After the cell forwarding of the cells #3 to #5, the pointer B is updated from #4 to #7, in response to the fact that three cells are forwarded. As thus described, the pointer to be used in forwarding cells is selected so that the waiting time is reduced as short as possible in accordance with the circumstances, to thereby reduces the delay in cell spreading.

In another exemplary embodiment, the buffer manager 25 within each input interface selects the pointer to be used in cell spreading in a different way. In the exemplary embodiment described above, the pointer is selected to be used in cell spreading, so that the waiting time is reduced as short as possible from the completion of the preparation of the cell forwarding in the input interface to the actual cell forwarding. According to the inventor's study, it is desirable that the pointer values of the pointers are uniformly distributed over the allowed pointer value range (from one to N).

In order to uniformly distribute the pointer values of the pointers, the buffer manager 25 selects the pointer to be used in cell spreading as follows:

First, the buffer manager 25 determines the pointer containing the pointer value which causes the shortest waiting time. Hereinafter, such pointer is referred to as the least waiting time pointer).

Next, the buffer manager 25 determines one or more pointers containing pointer values, the difference of which from the pointer value of the least waiting time pointer are equal to or less than a predetermined value, including the least waiting time pointer. Hereinafter, such pointer(s) is referred to as the neighbor pointer(s). It should be noted that the neighbor pointer(s) always includes the least waiting time pointer.

When there are two or more neighbor pointers, the buffer manager 25 finally selects one of the neighbor pointers so that the pointer value of the selected pointer is farthest from the pointer value of the least waiting time pointer.

When there is only one neighbor pointer, the buffer manager 25 selects the only neighbor pointer as the pointer to be used in cell spreading. It should be noted that, the only neighbor pointer is always the least waiting time pointer in this case.

Such selection of the pointer to be used in cell spreading allows distributing the pointer values of the pointers, thereby reducing the delay time in cell spreading from the input interfaces 11-1 to 11-N to the intermediate buffers 13-1 to 13-N.

FIG. 15 is a diagram illustrating an exemplary operation for cell spreading in this exemplary embodiment, for the case that two pointers A and B are prepared for each output interface (that is, for the case for M being two). In this example, it is assumed that the number N of the input interfaces 11-1 to 11-N is eight, and that cells of the same destination output interface arrive at the same input interface. The neighbor pointer(s) is defined as a pointer(s) containing a pointer value, the difference of which from the pointer value of the least waiting time pointer is one or less. Initially, the pointers A and B are set to #7 and #2, respectively.

The cells #1 and #2 get ready to be forwarded at the time slot “5” in the present input interface. Since the pointer values of the pointers A and B are #7 and #2, the pointer A, which causes the least waiting time, is selected as the pointer to be used in cell forwarding. The cells #1 and #2 wait to be forwarded until the input-side crossbar switch 12 provides the connection between the present input interface and the intermediate buffer 13-8 as indicated by the pointer A. The cells #1 and #2 are forwarded to intermediate buffer 13-8 and 13-1 at the time slot “8” and “9”, respectively. After the cell forwarding, the pointer A is updated from #7 to #1.

After that, the cells #3 to #5 are get ready to be forwarded at the time slot “12” in the present input interface. Although the pointer A, containing a pointer value of #1, causes the least waiting time, the pointer B is selected as the pointer to be used in cell forwarding, since the difference of the pointer value of the pointer B from that of the least waiting time pointer (that is, the pointer A) is equal to one, and the pointer B causes longer waiting time. Therefore, the cells #3 to #5 are sequentially forwarded to the intermediate buffers 13-3 to 13-5, starting from the time slots “19” at which the input-side crossbar switch 12 provides a connection between the present input interface and the intermediate buffer 13-3. The pointer B is updated from #2 to #5, in response to the fact that three cells are forwarded, thereby widely distributing the pointer values of the pointers A and B.

In still another exemplary embodiment, the buffer manager 25 within each input interface selects the pointer to be used in cell spreading in a different way. As described above, it is desirable that the pointer values of the pointers are uniformly distributed over the allowed pointer value range (from one to N). This exemplary embodiment addresses uniformly distributing the pointer values of the pointers in a different way.

In this exemplary embodiment, the buffer manager 25 defines selected one(s) of the pointers as a “forward pointer(s)”, and the remaining one(s) as a “reverse pointer(s)”. The forward pointer is a pointer whose pointer value is updated incrementally in response to the number of forwarded cells in cell spreading, while the reverse pointer is a pointer hose pointer value is updated decrementally.

When a forward pointer containing a pointer value of #6 is selected to be used in cell spreading, for example, cells are forwarded to relevant intermediate buffers starting from the intermediate buffer 13-7 as indicated by the selected forward pointer. After the cell forwarding, the selected forward pointer is updated so as to indicate the intermediate buffer to which the final cell is forwarded; that is, the selected forward pointer is updated to the sum of the original pointer value and the number of the forwarded cells (under modulo N arithmetic). When three cells are forwarded, for example, the relevant forward pointer is updated to #9.

When a reverse pointer containing a pointer value of #6 is selected to be used in cell spreading of three cells, for example, the three cells are sequentially forwarded to the intermediate buffers 13-4, 13-5 and 13-6, respectively. It should be noted that the reverse pointer indicates the intermediate buffer to which the final cell is to be forwarded. After the cell forwarding, the selected reverse pointer is updated so as to indicate the intermediate buffer previous to the intermediate buffer to which the leading cell is forwarded; that is, the selected forward pointer is updated to the difference obtained by subtracting the number of the forwarded cells from the original pointer value (under modulo N arithmetic). When three cells are forwarded, for example, the relevant reverse pointer is updated to #3.

The use of the forward and reverse pointers allows widely distributing the pointer values thereof, and thereby reducing the delay in cell spreading from the input interfaces to the intermediate buffers.

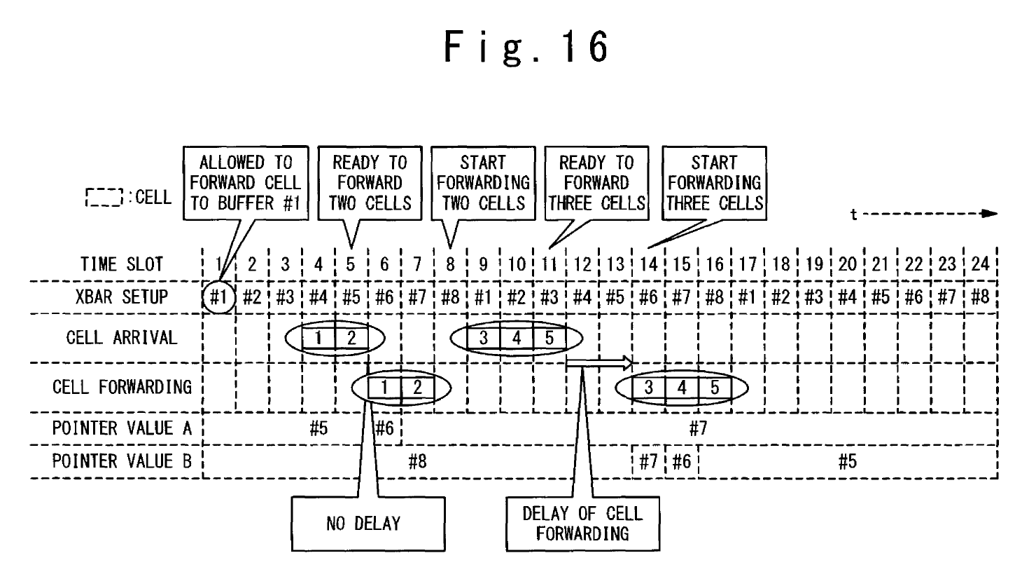

FIG. 16 is a diagram illustrating an exemplary operation for cell spreading in this exemplary embodiment, for the case that two pointers A and B are prepared for each output interface (that is, for the case for M being two). In this example, it is assumed that the number N of the input interfaces 11-1 to 11-N is eight, and that cells of the same destination output interface arrive at the same input interface. The pointer A is defined as a forward pointer, while the pointer B is defined as a reverse pointer. Initially, the pointers A and B are set to #5 and #8, respectively.

The cells #1 and #2 get ready to be forwarded at the time slot “5” in the present input interface. Since the pointers A and B are set to #5 and #8, respectively, the use of the forward pointer A allows forwarding the cells #1 and #2 starting from the intermediate buffer 13-6, and the use of the reverse pointer B allows forwarding the cells #1 and #2 starting from the intermediate buffer 13-7; it should be noted that the cells #1 and #2 are necessarily forwarded starting from the intermediate buffer 13-7 in order to forward the final cell (the cell #2) to the intermediate buffer 13-8 as indicated by the pointer B. In this case, the pointer A, which causes the least waiting time, is selected in forwarding the cells #1 and #2. After the cell forwarding, the pointer A is updated from #5 to #7, in response to the fact that two cells have been forwarded.

After that, the cells #3 to #5 get ready to be forwarded at the time slot “12” in the present input interface. At this time, the use of the forward pointer A allows forwarding the cells #3 to #5 starting from the intermediate buffer 13-8, and the use of the reverse pointer B allows forwarding the cells #1 and #2 starting from the intermediate buffer 13-6; it should be noted that the cells #3 to #5 are necessarily forwarded starting from the intermediate buffer 13-6 in order to forward the final cell (the cell #5) to the intermediate buffer 13-8 as indicated by the pointer B. In this case, the pointer B, which causes the least waiting time, is selected in forwarding the cells #3 to #5. After the cell forwarding, the pointer B is updated from #8 to #5, in response to the fact that three cells have been forwarded.

In summary, the load-balanced switch of the above-described exemplary embodiment, which includes a plurality of pointers indicative of one of the intermediate buffers for each output interface, is designed to use selected one of the pointers in cell spreading, which causes a reduced waiting time. This is advantageous over the FOFF scheme, in which only one intermediate buffer is determined as the intermediate buffer starting from which the cells are forwarded, since the FOFF scheme memorizes the intermediate buffer to which the final cell is forwarded for each output interface, and determines the intermediate buffer to which a next cell is forwarded, depending on the intermediate buffer to which the final cell is forwarded.

It is apparent that the present invention is not limited to the above-described embodiments, which may be modified and changed without departing from the scope of the invention.

What is claimed is:

1. A switch apparatus comprising:
a plurality of input interfaces;
a plurality of intermediate buffers;
a plurality of output interfaces;
an input-side switch providing connections between the input interfaces and the intermediate buffers; and
an output-side switch providing connections between the intermediate buffers and the output interfaces,
wherein each of said plurality of input interfaces is provided with a plurality of pointers for each of said output interfaces, each of said plurality of pointers containing a pointer value indicating one of said intermediate buffers, and
wherein said plurality of input interfaces are each designed to select one of said plurality of pointers and to sequentially forward cells of the same destination output interface to desired ones of said plurality of intermediate buffers starting from one of said plurality of intermediate buffers as indicated by a pointer value contained in said selected one of said plurality of pointers.

2. The switch apparatus according to claim 1, wherein each of said plurality of input interfaces is designed to store first queues associated with said plurality of output interfaces, respectively, to place respective arriving cells in selected ones of said first queues on the basis of destination output interfaces thereof, and to uniformly forward said cells of the same destination output interface to said desired ones of said intermediate buffers through said input-side switch,
wherein each of said plurality of intermediate buffers is designed to store second queues associated with said plurality of output interfaces, respectively, to place respective cells received from said input-side switch in selected ones of said second queues on the basis of destination output interfaces thereof, and to sequentially forward cells to desired ones of said output interfaces through said output-side crossbar switch, and
wherein each of said output interfaces is designed to check an order of cells received from said output-side crossbar switch, and to provide cell reordering for said cells received from said output-side crossbar switch.

3. The switch apparatus according to claim 1, wherein said each plurality of input interfaces is designed to select said selected one of said plurality of pointers so that a waiting time is reduced as short as possible in forwarding said cells to said desired ones of said plurality of intermediate buffers.

4. The switch apparatus according to claim 1, wherein said each plurality of input interfaces is designed to determine a least waiting time pointer which causes the least waiting time out of said plurality of pointers, to determine one or more neighbor pointers each containing a pointer value, the difference of which from a pointer value of said least waiting time pointer is equal to or less than a predetermined value, said neighbor pointers including said least waiting time pointer, and to determine one of said neighbor pointers as said selected one of said plurality of pointers so that said determined one of said neighbor pointers causes the largest waiting time output said neighbor pointers, when there are multiple neighbor pointers.

5. The switch apparatus according to claim 1, wherein said plurality of pointers includes:
a forward pointer; and
a reverse pointer;
wherein said plurality of input interfaces are each designed to incrementally update said selected one of said plurality of pointers when said forward pointer is selected as said selected one, and to decrementally update said selected one of said plurality of pointers when said reverse pointer is selected as said selected one.

6. The switch apparatus according to claim 1, wherein said plurality of input interfaces are each designed to update said selected one of said plurality of pointers in response to a number of said cells forwarded to said desired ones of said plurality of intermediate buffers.

7. A switching method comprising:
providing a switch apparatus including a plurality of input interfaces, a plurality of intermediate buffers, and a plurality of output interfaces, wherein each of said plurality of input interfaces includes a plurality of pointers for each of said plurality of output interfaces, and each of said plurality of pointers indicates one of said plurality of intermediate buffers;
selecting one of said plurality of pointers within one of said input interfaces; and
sequentially forwarding cells of the same destination output interface from said one of said input interfaces to desired ones of said plurality of intermediate buffers starting from selected one of said plurality of intermediate buffers as indicated by a pointer value contained in said selected one of said plurality of pointers.

8. The method according to claim 7, wherein said selected one of said plurality of pointers is selected so that a waiting time is reduced as short as possible in forwarding said cells to said desired ones of said plurality of intermediate buffers.

9. The method according to claim 7, further comprising:
updating said selected one of said plurality of pointers in response to a number of said cells forwarded to said desired ones of said plurality of intermediate buffers.

10. The method according to claim 7, wherein said sequentially forwarding includes:
placing respective arriving cells in selected ones of first queues within said one of said input interfaces, on the basis of destination output interfaces of said arriving cells, associated with said output interfaces, respectively; and
forwarding said cells of the same destination output interface from said one of said input interfaces to said desired ones of said plurality of intermediate buffers through an input-side switch;
wherein said method further comprising:
by each of said plurality of intermediate buffers, placing respective cells received from said input-side switch in selected ones of second queues associated with said output interfaces, respectively, on the basis of destination output interfaces thereof,
sequentially forwarding cells to desired ones of said output interfaces through said output-side crossbar switch through an output-side switch; and
by each of said output interfaces, checking an order of cells received from said intermediate buffers, and providing cell reordering for said cells received from said intermediate buffers.

11. A recording medium which records a program that when executed controls a switch apparatus including a plurality of input interfaces, a plurality of intermediate buffers, and a plurality of output interfaces wherein each of said plurality of input interfaces includes a plurality of pointers for each of said plurality of output interfaces, and each of said plurality of pointers indicates one of said plurality of intermediate buffers to perform a method comprising:
selecting one of said plurality of pointers within one of said input interfaces; and
sequentially forwarding cells of the same destination output interface from said one of said input interfaces to desired ones of said plurality of intermediate buffers starting from selected one of said plurality of intermediate buffers as indicated by a pointer value contained in said selected one of said plurality of pointers.
